(19) United States
(12) Patent Application Publication
(10) Pub. No.: US 2026/0209422 A1
(43) Pub. Date: Jul. 23, 2026

(54) PARTIALLY FLUORINATED AMPHIPHILIC BLOCK COPOLYMER AND POLYMER MEMBRANE FOR GAS SEPARATION COMPRISING THE SAME

(71) Applicant: UIF (University Industry Foundation), Yonsei University, Seoul (KR)

(72) Inventors: Jong Hak KIM, Seoul (KR); Seung Jae MOON, Seoul (KR)

(73) Assignee: UIF (University Industry Foundation), Yonsei University, Seoul (KR)

(21) Appl. No.: 19/455,526

(22) Filed: Jan. 21, 2026

(30) Foreign Application Priority Data
Jan. 23, 2025 (KR) 10-2025-0010148

(51) Int. Cl. C08F 293/00; B01D 53/22; B01D 67/00; B01D 69/02; B01D 69/10; B01D 69/12; B01D 71/80; C09D 153/00

(52) U.S. Cl. CPC C08F 293/005; B01D 53/228; B01D 67/0002; B01D 69/02; B01D 69/107; B01D 69/1213; B01D 71/80; C09D 153/00; B01D 2257/504; B01D 2325/04; B01D 2325/39; C08F 2438/03

(57) ABSTRACT

The present invention provides an amphiphilic block copolymer for a gas separation membrane represented by the Formula 1. Thereby, the amphiphilic block copolymer for a gas separation membrane of the present invention can be applied to a gas separation membrane to implement significantly high carbon dioxide permeability and carbon dioxide/nitrogen selectivity compared to industrial requirement performance (carbon dioxide permeability>1000 GPU, carbon dioxide/nitrogen selectivity>20) while having high mechanical strength, and can achieve excellent gas separation performance only with the structural characteristics of the polymer without applying a functional nanomaterial filler for improving gas separation performance.

### CROSS-REFERENCES TO RELATED APPLICATIONS

This application claims priority to Korean Patent Application No. 10-2025-0010148 filed on Jan. 23, 2025, and all the benefits accruing therefrom under 35 U.S.C.119, the contents of which in its entirety are herein incorporated by reference.

### BACKGROUND OF THE INVENTION

### Technical Field

The present invention relates to a polymer membrane for gas separation.

### Background Art

Carbon dioxide emissions due to the indiscriminate use of fossil fuels are further deteriorating the global environment. Carbon dioxide causes global warming through the greenhouse effect and consequently contributes to climate change and sea-level rise.

Accordingly, amine absorption methods, adsorbents, liquefaction distillation methods, membrane separation technologies, etc. are being studied as carbon dioxide capture technologies.

Among these, membrane separation technology is receiving much attention because it can be applied to various capture processes and is simple and economical in terms of manufacturing and operation. However, since separation membranes utilizing polymer materials have a trade-off relationship between permeability and selectivity, much research is being conducted to manufacture separation membranes having high permeability and selectivity simultaneously.

Recently, thin-film composite membranes manufactured by coating a selective layer with a thickness of 100-1000 nm on a porous support are being actively researched. This is because such thin-film composite membranes exhibit high separation performance compared to conventional amine absorption methods due to their high gas permeability.

Meanwhile, it is well known that the ethylene oxide functional group has high affinity due to dipole-dipole interaction with carbon dioxide, and a representative material having such a functional group is polyethylene oxide (PEO). However, PEO-based polymer materials have limitations in being applied to actual processes due to weak mechanical strength caused by high crystallinity and low permeability. Therefore, research and development on new separation membrane materials that improve the weak mechanical strength and low gas selectivity possessed by gas separation membranes using PEO polymers are required.

### PRIOR ART DOCUMENTS

1. Korean Patent Application Publication No. 10-2021-0116932
2. Japanese Patent Application Publication No. 2023-030786

### BRIEF SUMMARY OF THE INVENTION

An object of the present invention is to provide an amphiphilic block copolymer for a gas separation membrane and a gas separation membrane comprising the same, which can achieve excellent gas separation performance according to the characteristics of the polymer structure without the addition of MOF (metal-organic framework) or COF (covalent organic framework), which are functional nanomaterial fillers added to improve gas separation performance in conventional mixed matrix separation membranes, require no technical device to improve compatibility and interfacial defects between the polymer matrix and the filler by not including a filler, have high mechanical strength, and can implement significantly high carbon dioxide permeability and carbon dioxide/nitrogen selectivity compared to industrial requirement performance.

According to an aspect of the present invention, there is provided an amphiphilic block copolymer for a gas separation membrane represented by the following Formula 1.

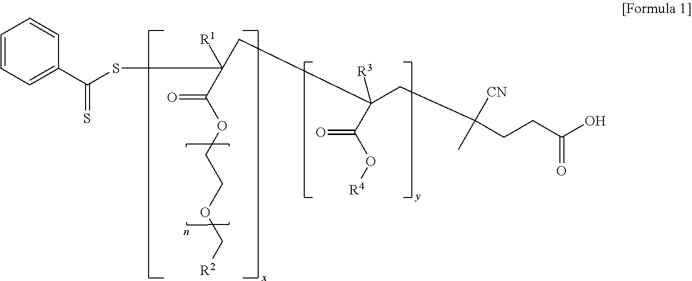

In Formula 1,
n is an integer of 5 to 30 as the number of repeating units,
x is an integer of 60 to 240 as the number of repeating units,
y is an integer of 30 to 80 as the number of repeating units,
x:y is 2:1 to 3:1, and
R¹ is a hydrogen atom, or a C₁ to C₂₀ alkyl group,
R² is a hydrogen atom, or a C₁ to C₂₀ alkyl group,
R³ is a hydrogen atom, or a C₁ to C₂₀ alkyl group,
R⁴ is

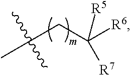

and
m is an integer of 1 to 10 as the number of repeating units, and
R⁵ to R⁷ are each independently a hydrogen atom or a fluoro group, and at least one or more are fluoro groups.

Preferably, in Formula 1,
n is an integer of 7 to 15 as the number of repeating units,
x is an integer of 80 to 200 as the number of repeating units,
y is an integer of 40 to 70 as the number of repeating units,
x:y is 2:1 to 3:1, and
R¹ is a C₁ to C₁₀ alkyl group,
R² is a hydrogen atom, or a C₁ to C₁₀ alkyl group,
R³ is a C₁ to C₁₀ alkyl group,
R⁴ is

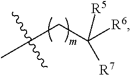

and
m is an integer of 1 to 5 as the number of repeating units, and
R⁵ to R⁷ are each independently a hydrogen atom or a fluoro group, and at least two or more may be fluoro groups.

More preferably, in Formula 1,
n is an integer of 8 to 12 as the number of repeating units,
x is an integer of 100 to 150 as the number of repeating units,
y is an integer of 45 to 55 as the number of repeating units,
x:y is 2:1 to 3:1, and
R¹ is a C₁ to C₄ alkyl group,
R² is a hydrogen atom, or a C₁ to C₄ alkyl group,
R³ is a C₁ to C₄ alkyl group,
R⁴ is

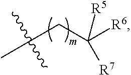

and
m is an integer of 1 to 3 as the number of repeating units, and
R⁵ to R⁷ may be fluoro groups.

The amphiphilic block copolymer may be one in which chains are aggregated to form a hexagonal column structure.

According to another aspect of the present invention, there is provided a method for preparing an amphiphilic block copolymer for a gas separation membrane comprising the steps of:
(a) preparing a macro RAFT agent represented by the following Formula 3 by reacting a free radical polymerization initiator, CPAD (4-cyano-4-(phenylcarbonothioylthio)pentanoic acid), and a monomer represented by the following Formula 2 in an organic solvent; and
(b) preparing an amphiphilic block copolymer represented by the following Formula 1 by subjecting a free radical polymerization initiator, the macro RAFT agent represented by the following Formula 3, and a monomer represented by the following Formula 4 to reversible addition-fragmentation chain transfer (RAFT) polymerization in an organic solvent.

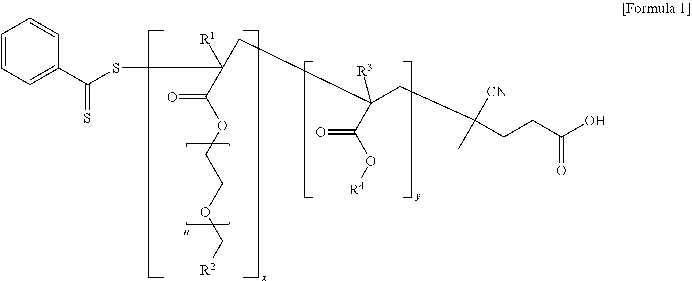

In Formula 1,
n is an integer of 5 to 30 as the number of repeating units,
x is an integer of 60 to 240 as the number of repeating units,
y is an integer of 30 to 80 as the number of repeating units,
x:y is 2:1 to 3:1, and
R¹ is a hydrogen atom, or a C₁ to C₂₀ alkyl group,
R² is a hydrogen atom, or a C₁ to C₂₀ alkyl group,
R³ is a hydrogen atom, or a C₁ to C₂₀ alkyl group,
R⁴ is

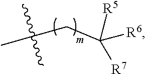

and
m is an integer of 1 to 10 as the number of repeating units, and
R⁵ to R⁷ are each independently a hydrogen atom or a fluoro group, and at least one or more are fluoro groups.

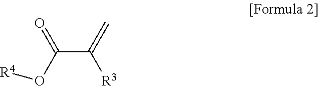

In Formula 2,
R³ is a hydrogen atom, or a C₁ to C₂₀ alkyl group,
R⁴ is

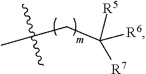

and
m is an integer of 1 to 10 as the number of repeating units, and
R⁵ to R⁷ are each independently a hydrogen atom or a fluoro group, and at least one or more are fluoro groups.

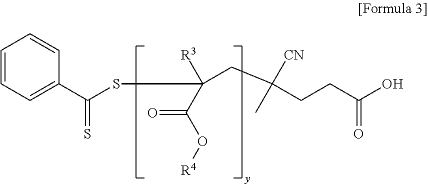

In Formula 3,
y is an integer of 30 to 150 as the number of repeating units,
R³ is a hydrogen atom, or a C₁ to C₂₀ alkyl group,
R⁴ is

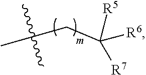

and
m is an integer of 1 to 10 as the number of repeating units, and
R⁵ to R⁷ are each independently a hydrogen atom or a fluoro group, and at least one or more are fluoro groups.

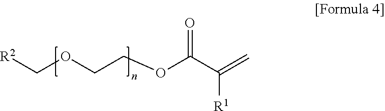

In Formula 4,
n is an integer of 5 to 30 as the number of repeating units,
R¹ is a hydrogen atom, or a C₁ to C₂₀ alkyl group, and R
² is a hydrogen atom, or a C₁ to C₂₀ alkyl group.

Preferably, in Formula 1,
n is an integer of 7 to 15 as the number of repeating units,
x is an integer of 80 to 200 as the number of repeating units,
y is an integer of 40 to 70 as the number of repeating units,
x:y is 2:1 to 3:1, and
R¹ is a C₁ to C₁₀ alkyl group,
R² is a hydrogen atom, or a C₁ to C₁₀ alkyl group,
R³ is a C₁ to C₁₀ alkyl group,
R⁴ is

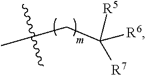

and
m is an integer of 1 to 5 as the number of repeating units, and
R⁵ to R⁷ are each independently a hydrogen atom or a fluoro group, and at least two or more are fluoro groups,
and in Formula 2,
R³ is a C₁ to C₁₀ alkyl group,
R⁴ is

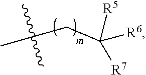

and
m is an integer of 1 to 5 as the number of repeating units, and
R⁵ to R⁷ are each independently a hydrogen atom or a fluoro group, and at least two or more are fluoro groups,
and in Formula 3,
y is an integer of 20 to 100 as the number of repeating units.
R³ is a C₁ to C₁₀ alkyl group,
R⁴ is

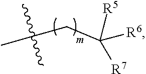

and
m is an integer of 1 to 5 as the number of repeating units, and
R⁵ to R⁷ are each independently a hydrogen atom or a fluoro group, and at least two or more are fluoro groups,
and in Formula 4,
n is an integer of 7 to 15 as the number of repeating units,
R¹ is a C₁ to C₁₀ alkyl group, and
R² is a hydrogen atom, or a C₁ to C₁₀ alkyl group.

More preferably, in Formula 1,
n is an integer of 8 to 12 as the number of repeating units,
x is an integer of 100 to 150 as the number of repeating units,
y is an integer of 45 to 55 as the number of repeating units,
x:y is 2:1 to 3:1, and
R¹ is a C₁ to C₄ alkyl group,
R² is a hydrogen atom, or a C₁ to C₄ alkyl group,
R³ is a C₁ to C₄ alkyl group,
R⁴ is

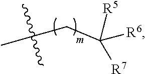

and
m is an integer of 1 to 3 as the number of repeating units, and
R⁵ to R⁷ are fluoro groups,
and in Formula 2,
R¹ is a C₁ to C₄ alkyl group,
R² is a hydrogen atom, or a C₁ to C₄ alkyl group,
R³ is a C₁ to C₄ alkyl group,
R⁴ is

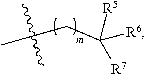

and
m is an integer of 1 to 3 as the number of repeating units, and
R⁵ to R⁷ are fluoro groups,
and in Formula 3,
y is an integer of 30 to 80 as the number of repeating units,
R³ is a C₁ to C₄ alkyl group,
R⁴ is

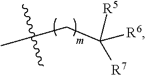

and
m is an integer of 1 to 3 as the number of repeating units, and
R⁵ to R⁷ are fluoro groups,
and in Formula 4,
n is an integer of 8 to 12 as the number of repeating units,
R¹ is a C₁ to C₄ alkyl group, and
R² is a hydrogen atom, or a C₁ to C₄ alkyl group.

The free radical polymerization initiator may be any one selected from azobisisobutyronitrile (AIBN), ammonium persulfate, and hydroperoxide.

In step (a), the reaction may be performed at 60 to 80° C.

In step (a), the reaction may be performed in an inert atmosphere.

In step (a), the organic solvent may be any one selected from n-butanol, tetrahydrofuran, chloroform, ethyl acetate, 2-butanone, 1,4-dioxane, acetone, and acetonitrile.

In step (b), the macro RAFT agent represented by Formula 3 and the monomer represented by Formula 4 may be polymerized in a weight ratio of 1:6 to 1:12.

In step (b), the reversible addition-fragmentation chain transfer (RAFT) polymerization may be performed at 60 to 70° C.

In step (b), the reaction may be performed in an inert atmosphere.

According to yet another aspect of the present invention, there is provided a gas separation membrane comprising the amphiphilic block copolymer for a gas separation membrane.

The gas separation membrane may further comprise a porous support, and the gas separation membrane may be coated on the porous support.

The porous support may include any one selected from polysulfone, polyethersulfone, polymethyl methacrylate, polyethylene, polypropylene, polyoxymethylene, polyetheretherketone, polyethylene terephthalate, polyacrylonitrile, cellulose acetate, polyamide, polyimide, polyamideimide, polyetherimide, polyvinylidene fluoride, polyvinyl alcohol, and polyarylate.

The gas separation membrane may be coated to a thickness of 100 to 1000 nm.

The gas separation membrane may be for separating one or more gases selected from carbon dioxide, nitrogen, methane, and hydrogen.

The gas separation membrane may have a carbon dioxide permeability of 1900 to 2000 GPU and a CO₂/N₂ selectivity of 30 to 40.

According to yet another aspect of the present invention, there is provided a method for manufacturing a gas separation membrane comprising the steps of:
(A) preparing an amphiphilic block copolymer for a gas separation membrane according to the preparation method of any one of claims 5 to 12;
(B) preparing an amphiphilic block copolymer solution by dissolving the amphiphilic block copolymer in an organic solvent; and
(C) coating the amphiphilic block copolymer solution on a porous support and then drying.

In step (B), the organic solvent may be any one selected from water, dimethyl sulfoxide, dimethylformamide, acetic acid, acetonitrile, ethanol, methanol, and acetone.

Prior to step (C), PTMSP (poly(1-(trimethylsilyl-1-propyne))) may be additionally coated on the porous support.

The amphiphilic block copolymer for a gas separation membrane and the gas separation membrane comprising the same of the present invention can achieve excellent gas separation performance according to the characteristics of the polymer structure without the addition of MOF (metal-organic framework) or COF (covalent organic framework), which are functional nanomaterial fillers added to improve gas separation performance in conventional mixed matrix separation membranes, require no technical device to improve compatibility and interfacial defects between the polymer matrix and the filler by not including a filler, and can implement significantly high carbon dioxide permeability and carbon dioxide/nitrogen selectivity compared to industrial requirement performance (carbon dioxide permeability>1000 GPU, carbon dioxide/nitrogen selectivity>20) while having high mechanical strength.

### BRIEF DESCRIPTION OF THE DRAWINGS

FIGS. 1A and 1B show the FTIR analysis results for the PTF block copolymer of Example 1, the PTF random copolymer of Comparative Example 1, and the monomers according to Experimental Example 1.

FIGS. 2A and 2B show the 1H NMR results of the PTF block copolymer of Example 1 and the PTF random copolymer of Comparative Example 1 according to Experimental Example 1.

FIGS. 3A and 3B show photographs of the PTF block copolymer of Example 1 and the PTF random copolymer of Comparative Example 1 according to Experimental Example 2.

FIG. 4 shows the SAXS (Small-Angle X-ray Scattering) analysis results for the PTF block copolymer of Example 1 and the PTF random copolymer of Comparative Example 1 according to Experimental Example 2.

FIGS. 5A and 5B show TEM images for the PTF block copolymer of Example 1 and the PTF random copolymer of Comparative Example 1 according to Experimental Example 3.

FIGS. 6A and 6B show the analysis results according to Differential Scanning Calorimetry (DSC) and load-displacement curves obtained through nano-indenter analysis for the PTF block copolymer of Example 1 and the PTF random copolymer of Comparative Example 1 according to Experimental Example 5.

FIGS. 7A and 7B show a SEM image of the cross-section of the TFC separation membrane of Example 2 according to Experimental Example 6 (a) and a SEM image of the cross-section of the TFC separation membrane of Comparative Example 2 (b).

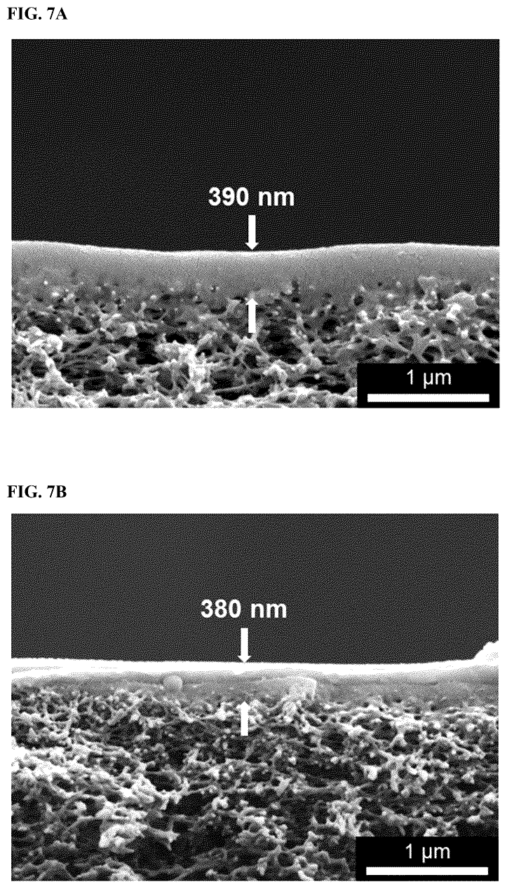

FIGS. 8A and 8B show the gas separation performance analysis results of the TFC separation membrane of Example 2, the TFC separation membrane of Comparative Example 2, and various known TFC separation membranes according to Experimental Example 6.

### DETAILED DESCRIPTION OF THE INVENTION

Hereinafter, several aspects and various embodiments of the present invention will be described in more detail.

Hereinafter, examples of the present invention will be described in detail with reference to the accompanying drawings so that those of ordinary skill in the art to which the present invention pertains can easily practice the present invention.

However, the following description is not intended to limit the present invention to specific embodiments, and detailed descriptions of related known technologies will be omitted if it is determined that they may obscure the gist of the present invention in describing the present invention.

Terms used herein are only used to describe specific examples and are not intended to limit the present invention. Singular expressions include plural expressions unless the context clearly indicates otherwise. In this application, terms such as “comprise” or “have” are intended to designate that the features, numbers, steps, operations, components, or combinations thereof described in the specification exist, and should be understood as not precluding the possibility of the existence or addition of one or more other features or numbers, steps, operations, components, or combinations thereof.

Hereinafter, the amphiphilic block copolymer for a gas separation membrane of the present invention will be described.

According to one embodiment of the present invention, the amphiphilic block copolymer for a gas separation membrane of the present invention is characterized in that it is represented by the following Formula 1.

### [Formula 1]

In Formula 1,
n is an integer of 5 to 30 as the number of repeating units,
x is an integer of 60 to 240 as the number of repeating units,
y is an integer of 30 to 80 as the number of repeating units,
x:y is 2:1 to 3:1, and
R¹ is a hydrogen atom, or a C₁ to C₂₀ alkyl group,
R² is a hydrogen atom, or a C₁ to C₂₀ alkyl group,
R³ is a hydrogen atom, or a C₁ to C₂₀ alkyl group,
R⁴ is

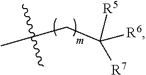

and
m is an integer of 1 to 10 as the number of repeating units, and
R⁵ to R⁷ are each independently a hydrogen atom or a fluoro group, and at least one or more are fluoro groups.

Preferably, in Formula 1,
n is an integer of 7 to 15 as the number of repeating units,
x is an integer of 80 to 200 as the number of repeating units,
y is an integer of 40 to 70 as the number of repeating units,
x:y is 2:1 to 3:1, and
R¹ is a C₁ to C₁₀ alkyl group,
R² is a hydrogen atom, or a C₁ to C₁₀ alkyl group,
R³ is a C₁ to C₁₀ alkyl group,
R⁴ is

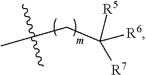

and
m is an integer of 1 to 5 as the number of repeating units, and
R⁵ to R⁷ are each independently a hydrogen atom or a fluoro group, and at least two or more may be fluoro groups.

More preferably, in Formula 1,
n is an integer of 8 to 12 as the number of repeating units,
x is an integer of 100 to 150 as the number of repeating units,
y is an integer of 45 to 55 as the number of repeating units,
x:y is 2:1 to 3:1, and
R¹ is a C₁ to C₄ alkyl group,
R² is a hydrogen atom, or a C₁ to C₄ alkyl group,
R³ is a C₁ to C₄ alkyl group,
R⁴ is

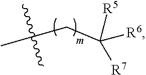

and
m is an integer of 1 to 3 as the number of repeating units, and
R⁵ to R⁷ may be fluoro groups.

The amphiphilic block copolymer can have high amphiphilicity and carbon dioxide affinity by polymerizing a block-type copolymer using a monomer of Formula 2 containing —CF₃, —CF₂H, —CFH₂ groups which are superhydrophobic functional groups, and a monomer represented by Formula 4 abundantly containing ethylene oxide groups which are hydrophilic and simultaneously carbon dioxide-friendly functional groups.

In addition, the amphiphilic block copolymer represented by Formula 1 has excellent self-assembly ability, so it is characterized in that partially fluorinated chains aggregate to undergo microphase-separation, thereby forming a hexagonal column structure. Such a structure helps the permeation of carbon dioxide and can physically inhibit the diffusion of nitrogen gas.

According to another embodiment of the present invention, the present invention provides a method for preparing an amphiphilic block copolymer for a gas separation membrane. The amphiphilic block copolymer of the present invention can be prepared in a two-step process.

First, a macro RAFT agent represented by the following Formula 3 is prepared by reacting a free radical polymerization initiator, CPAD (4-cyano-4-(phenylcarbonothioylthio)pentanoic acid), and a monomer represented by the following Formula 2 in an organic solvent (step a).

The compound represented by Formula 2 may be represented by the following formula.

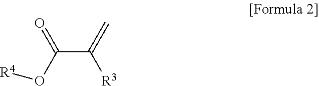

In Formula 2,
R³ is a hydrogen atom, or a C₁ to C₂₀ alkyl group,
R⁴ is

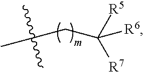

and
m is an integer of 1 to 10 as the number of repeating units, and
R⁵ to R⁷ are each independently a hydrogen atom or a fluoro group, and at least one or more are fluoro groups.

Preferably, in Formula 2,
R³ is a C₁ to C₁₀ alkyl group,
R⁴ is

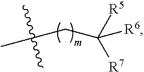

and
m is an integer of 1 to 5 as the number of repeating units, and
R⁵ to R⁷ are each independently a hydrogen atom or a fluoro group, and at least two or more may be fluoro groups.

More preferably, in Formula 2,
R¹ is a C₁ to C₄ alkyl group,
R² is a hydrogen atom, or a C₁ to C₄ alkyl group,
R³ is a C₁ to C₄ alkyl group,
R⁴ is

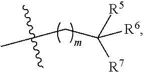

and
m is an integer of 1 to 3 as the number of repeating units, and
R⁵ to R⁷ may be fluoro groups.

The compound represented by Formula 3 may be represented by the following formula.

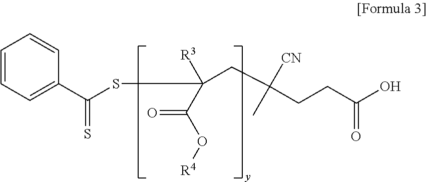

In Formula 3,
y is an integer of 30 to 150 as the number of repeating units,
R³ is a hydrogen atom or a C₁ to C₂₀ alkyl group,
R⁴ is

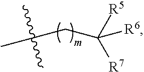

and
m is an integer of 1 to 10 as the number of repeating units, and
R⁵ to R⁷ are each independently a hydrogen atom or a fluoro group, and at least one or more are fluoro groups.

Preferably, in Formula 3,
y is an integer of 20 to 100 as the number of repeating units,
R³ is a C₁ to C₁₀ alkyl group,
R⁴ is

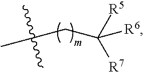

and
m is an integer of 1 to 5 as the number of repeating units, and
R⁵ to R⁷ are each independently a hydrogen atom or a fluoro group, and at least two or more may be fluoro groups.

More preferably, in Formula 3,
y is an integer of 30 to 80 as the number of repeating units,
R³ is a C₁ to C₄ alkyl group,
R⁴ is

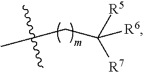

and
m is an integer of 1 to 3 as the number of repeating units, and
R⁵ to R⁷ may be fluoro groups.

The free radical polymerization initiator may be any one selected from azobisisobutyronitrile (AIBN), ammonium persulfate, and hydroperoxide, and preferably may be azobisisobutyronitrile.

The reaction may be performed at 60 to 80° C., and more preferably may be performed at 65 to 75° C. In the above temperature range, the synthesis yield of the macro RAFT agent represented by Formula 3 can be improved.

The reaction may be performed in an inert atmosphere.

The organic solvent may be any one selected from n-butanol, tetrahydrofuran, chloroform, ethyl acetate, 2-butanone, 1,4-dioxane, acetone, and acetonitrile, but the scope of the present invention is not limited thereto.

Next, an amphiphilic block copolymer represented by the following Formula 1 is prepared by subjecting a free radical polymerization initiator, the macro RAFT agent represented by Formula 3, and a monomer represented by the following Formula 4 to reversible addition-fragmentation chain transfer (RAFT) polymerization in an organic solvent (step b).

The monomer represented by Formula 4 may be represented by the following formula.

### [Formula 4]

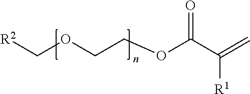

In Formula 4,
n is an integer of 5 to 30 as the number of repeating units,
R¹ is a hydrogen atom, or a C₁ to C₂₀ alkyl group, and
R² is a hydrogen atom, or a C₁ to C₂₀ alkyl group.

Preferably, in Formula 4,
n is an integer of 7 to 15 as the number of repeating units,
R¹ is a C₁ to C₁₀ alkyl group, and
R² is a hydrogen atom, or a C₁ to C₁₀ alkyl group.

More preferably, in Formula 4,
n is an integer of 8 to 12 as the number of repeating units,
R¹ is a C₁ to C₄ alkyl group, and
R² is a hydrogen atom, or a C₁ to C₄ alkyl group.

The amphiphilic block copolymer represented by Formula 1 may be represented by the following formula.

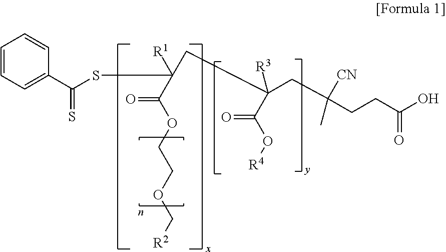

In Formula 1,
n is an integer of 5 to 30 as the number of repeating units,
x is an integer of 60 to 240 as the number of repeating units,
y is an integer of 30 to 80 as the number of repeating units,
x:y is 2:1 to 3:1, and
R¹ is a hydrogen atom, or a C₁ to C₂₀ alkyl group,
R² is a hydrogen atom, or a C₁ to C₂₀ alkyl group,
R³ is a hydrogen atom, or a C₁ to C₂₀ alkyl group,
R⁴ is

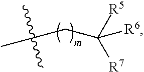

and
m is an integer of 1 to 10 as the number of repeating units, and
R⁵ to R⁷ are each independently a hydrogen atom or a fluoro group, and at least one or more are fluoro groups.

Preferably, in Formula 1,
n is an integer of 7 to 15 as the number of repeating units,
x is an integer of 80 to 200 as the number of repeating units,
y is an integer of 40 to 70 as the number of repeating units,
x:y is 2:1 to 3:1, and
R¹ is a C₁ to C₁₀ alkyl group,
R² is a hydrogen atom, or a C₁ to C₁₀ alkyl group,
R³ is a C₁ to C₁₀ alkyl group,
R⁴ is

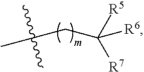

and
m is an integer of 1 to 5 as the number of repeating units, and
R⁵ to R⁷ are each independently a hydrogen atom or a fluoro group, and at least two or more may be fluoro groups.

More preferably, in Formula 1,
n is an integer of 8 to 12 as the number of repeating units,
x is an integer of 100 to 150 as the number of repeating units,
y is an integer of 45 to 55 as the number of repeating units,
x:y is 2:1 to 3:1, and
R¹ is a C₁ to C₄ alkyl group,
R² is a hydrogen atom, or a C₁ to C₄ alkyl group,
R³ is a C₁ to C₄ alkyl group,
R⁴ is

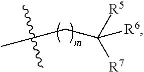

and
m is an integer of 1 to 3 as the number of repeating units, and
R⁵ to R⁷ may be fluoro groups.

The free radical polymerization initiator may be AIBN (2,2′-Azobis(2-methylpropionitrile) or BPO (Benzoyl peroxide).

The organic solvent may be any one selected from n-butanol, tetrahydrofuran, chloroform, ethyl acetate, 2-butanone, 1,4-dioxane, acetone, and acetonitrile, but the scope of the present invention is not limited thereto.

The macro RAFT agent represented by the following Formula 3 and the monomer represented by the following Formula 4 are preferably polymerized in a weight ratio of 1:6 to 1:12, and more preferably may be polymerized in a weight ratio of 1:8 to 1:10.

When the reversible addition-fragmentation chain transfer (RAFT) polymerization is performed at such a weight ratio to prepare the amphiphilic block copolymer of Formula 1, a tendency may appear whereas the ratio of the monomer of Formula 2 increases, it does not dissolve well in mild solvents such as ethanol and dissolves in highly toxic solvents such as tetrahydrofuran (THF) and acetonitrile (ACN) when manufacturing a thin-film composite membrane on a polysulfone support which is a porous support. Since such highly toxic organic solvents dissolve the polysulfone support during polymer solution coating, there is a problem that a polymer insoluble in a mild solvent cannot be applied to the manufacture of a thin-film composite membrane. Therefore, it is not preferable for the synthesis ratio of the monomer of Formula 2 to deviate from the above range.

On the other hand, if the ratio of the monomer represented by Formula 4 becomes higher than the above range, the block copolymer may have a viscous liquid state. Since a polymer in such a viscous liquid state can permeate into the pores of the porous support, a problem may occur in that both gas permeability and selectivity are lowered.

The reaction is preferably performed at 60 to 80° C., and more preferably may be performed at 65 to 75° C.

The reaction may be performed in an inert atmosphere.

By satisfying the reaction conditions, reversible addition-fragmentation chain transfer (RAFT) polymerization is smoothly performed, so that the yield of the desired amphiphilic block copolymer of Formula 1 can be improved.

According to another embodiment of the present invention, the present invention provides a gas separation membrane comprising the amphiphilic block copolymer for a gas separation membrane.

The gas separation membrane may further comprise a porous support, and the gas separation membrane may be coated on the porous support.

The porous support may be any one selected from polysulfone, polyethersulfone, polymethyl methacrylate, polyethylene, polypropylene, polyoxymethylene, polyetheretherketone, polyethylene terephthalate, polyacrylonitrile, cellulose acetate, polyamide, polyimide, polyamideimide, polyetherimide, polyvinylidene fluoride, polyvinyl alcohol, and polyarylate, but the scope of the present invention is not limited thereto.

The gas separation membrane may have a thickness of 100 to 1000 nm, preferably 200 to 600 nm, and more preferably 300 to 500 nm. If the thickness of the polymer membrane is less than 100 nm, the probability of defects occurring in the separation membrane may increase, and as a result, gas selectivity may decrease sharply. Also, if it exceeds 1000 nm, the gas permeation rate becomes slow, which may not be suitable for actual industrial application.

The gas separation membrane may be for separating one or more gases selected from carbon dioxide, nitrogen, methane, and hydrogen, and preferably may be for separating gases of carbon dioxide and nitrogen. At this time, the gas separation membrane may have a carbon dioxide permeability of 1900 to 2000 GPU and a CO₂/N₂ selectivity of 30 to 40.

According to yet another embodiment of the present invention, the method for manufacturing a gas separation membrane of the present invention is characterized by comprising the steps of: (A) preparing an amphiphilic block copolymer for a gas separation membrane according to the method for preparing an amphiphilic block copolymer for a gas separation membrane; (B) preparing an amphiphilic block copolymer solution by dissolving the amphiphilic block copolymer in an organic solvent; and (C) coating the amphiphilic block copolymer solution on a porous support and then drying.

The organic solvent may be any one selected from water, dimethyl sulfoxide, dimethylformamide, acetic acid, acetonitrile, ethanol, methanol, and acetone.

Prior to step (C), a PTMSP (poly(1-(trimethylsilyl-1-propyne))) layer may be additionally coated and used on the porous support. When coating the PTF block copolymer directly without the PTMSP layer, a phenomenon (infiltration) where the polymer solution permeates between the pores of the porous support occurs, which may cause defects in the separation membrane. PTMSP is a highly permeable polymer material with no gas selectivity, and cyclohexane may be used as an organic solvent during solution preparation. Since cyclohexane has very strong volatility compared to the ethanol/acetonitrile mixed solvent suitable for use in the PTF block copolymer solution, it hardly permeates into the porous support and can form a thin layer thereon.

Hereinafter, specific examples according to the present invention will be described.

### EXAMPLES

### Example 1: Synthesis of PTFEMA-b-POEM (PTF Block-Type Copolymer) (RAFT Polymerization Method)

### (1) Synthesis of Poly(TFEMA) Macro-RAFT Agent

A solution was prepared by dissolving 0.02 g of AIBN (2,2′-Azobis(2-methylpropionitrile) as an initiator, 0.12 g of CPAD (4-cyano-4-(phenylcarbonothioylthio)pentanoic acid) as a RAFT agent, and 20 g of TFEMA (2,2,2-trifluoroethyl methacrylate) monomer in 30 ml of 1,4-dioxane (AIBN:CPAD:TFEMA=1:6:1000 mass ratio). After purging the reaction flask for about 30 minutes, the solution was reacted at 70° C. for 24 hours. Thereafter, the polymer was purified by precipitating the reacted solution in an excess of n-hexane 4 times to obtain a polymer, which was then dried in a vacuum oven at 50° C. for 12 hours to obtain a poly(TFEMA) macro-RAFT agent polymer (yield: 70%).

The reaction of the poly(TFEMA) macro-RAFT agent synthesis of this step is shown in Reaction Scheme 1 below.

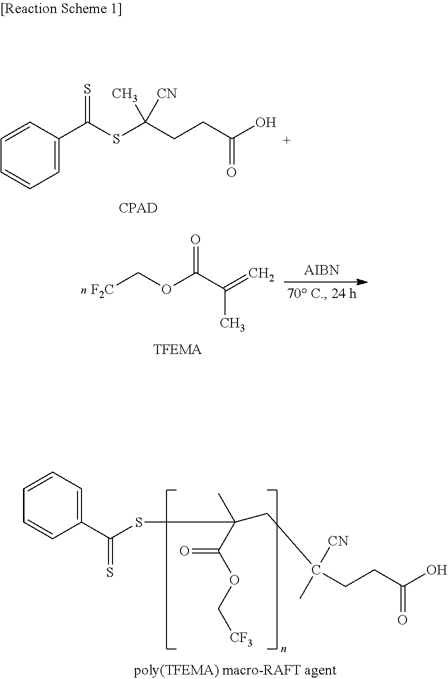

### (2) Synthesis of PTFEMA-b-POEM (PTF Block Copolymer) (RAFT Polymerization)

1 g of the poly(TFEMA) macro-RAFT agent prepared in step (1) was dissolved in 40 ml of 1,4-dioxane, and 9 g of POEM (poly(oxyethylene methacrylate)) and 0.01 g of AIBN as an initiator were additionally dissolved to prepare a solution. After purging the reaction flask with nitrogen gas for about 30 minutes, the solution was reacted at 70° C. for 24 hours. Thereafter, the reacted solution was precipitated in an excess of isopropyl alcohol (IPA) to obtain a polymer. The obtained polymer was washed with IPA three times and then dried in a vacuum oven at 50° C. for 12 hours to obtain PTFEMA-b-POEM (PTF block copolymer) (yield: 80%).

The reversible addition-fragmentation chain transfer (RAFT) polymerization reaction of the poly(TFEMA) macro-RAFT agent and POEM (poly(oxyethylene methacrylate)) of this step is shown in Reaction Scheme 2 below.

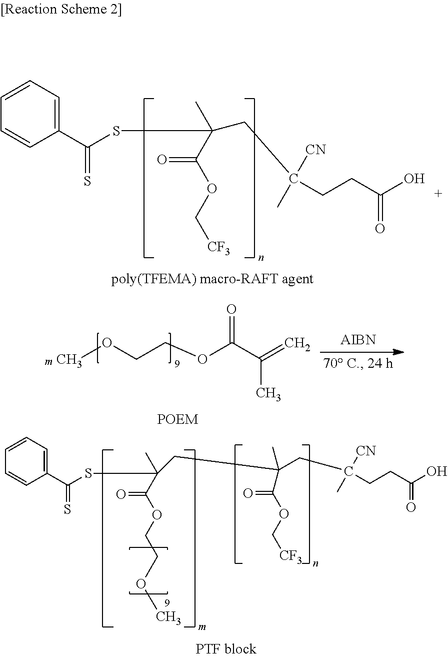

### Comparative Example 1: Synthesis of PTFEMA-r-POEM (PTF Random Copolymer) (Free Radical Polymerization Method, One-Step Polymerization)

1 g of monomer TFEMA (2,2,2-trifluoroethyl methacrylate), 9 g of POEM (poly(oxyethylene methacrylate)), and 0.004 g of initiator AIBN were dissolved in 40 ml of 1,4-dioxane. After purging the reaction flask with nitrogen gas for about 30 minutes, the solution was reacted at 70° C. for 24 hours. Thereafter, the reacted solution was precipitated in an excess of isopropyl alcohol (IPA) to obtain a polymer. The obtained polymer was washed with IPA three times and then dried in a vacuum oven at 50° C. for 12 hours to obtain PTFEMA-r-POEM (PTF random copolymer) (yield: 70%).

The free radical polymerization (FRP) reaction of TFEMA and POEM of Example 1 is shown in Reaction Scheme 3 below.

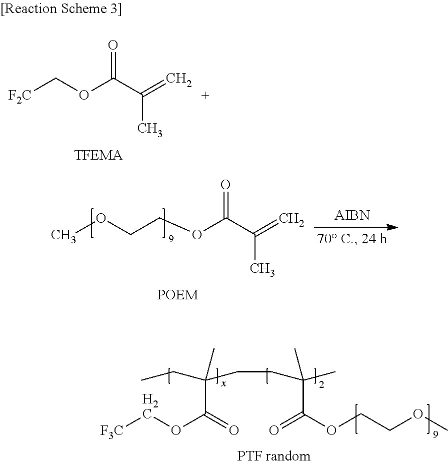

### Example 2: Preparation of Thin-Film Composite (TFC) Coated with PTF Block Copolymer

PTMSP (Poly(1-(trimethylsilyl-1-propyne))) was dissolved in cyclohexane to prepare a 1.5 wt % PTMSP solution, and then the PTMSP solution was bar-coated on a polysulfone support to prepare a PTMSP-coated support. Meanwhile, the PTF block copolymer prepared according to Example 1 was dissolved in a mixed solvent (ethanol:acetonitrile=8:2 volume ratio) to prepare a 5 wt % PTF block copolymer solution. The PTF block copolymer solution was bar-coated on the PTMSP-coated support and then dried in a vacuum oven at 50° C. for 25 hours to prepare a thin-film composite coated with the PTF block copolymer. At this time, in the PTF block copolymer-based gas separation membrane, the thickness of the gas selective layer made of the PTF block copolymer was 390 nm.

### Comparative Example 2: Preparation of Thin-Film Composite (TFC) Coated with PTF Random Copolymer

A thin-film composite coated with the PTF random copolymer was prepared in the same manner as in Example 2, except that the PTF random copolymer prepared according to Comparative Example 1 was used instead of the PTF block copolymer prepared according to Example 1.

### Experimental Examples

### Experimental Example 1: Confirmation of PTF Copolymer Synthesis

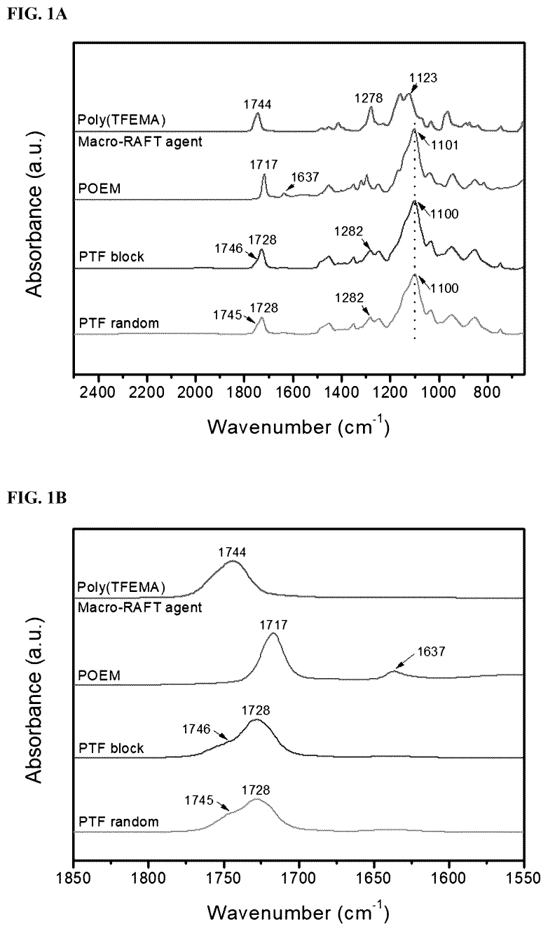

The Fourier Transform Infrared Spectroscopy (FTIR) analysis results for the PTF block copolymer of Example 1, the PTF random copolymer of Comparative Example 1, and the monomers used for their synthesis (FIG. 1A), and an enlargement of the 1850-1550 cm-1 region of the above results (FIG. 1B) are shown in FIGS. 1A and 1B.

According to this, characteristic peaks of the two monomers TFEMA (2,2,2-trifluoroethyl methacrylate) and POEM (poly(oxyethylene methacrylate)) appeared in the PTF block copolymer of Example 1 and the PTF random copolymer of Comparative Example 1, and in (b), the 1637 cm-1 peak of the C═C double bond of the two monomers TFEMA and POEM did not appear in the PTF block copolymer of Example 1 and the PTF random copolymer of Comparative Example 1, confirming that copolymerization occurred well.

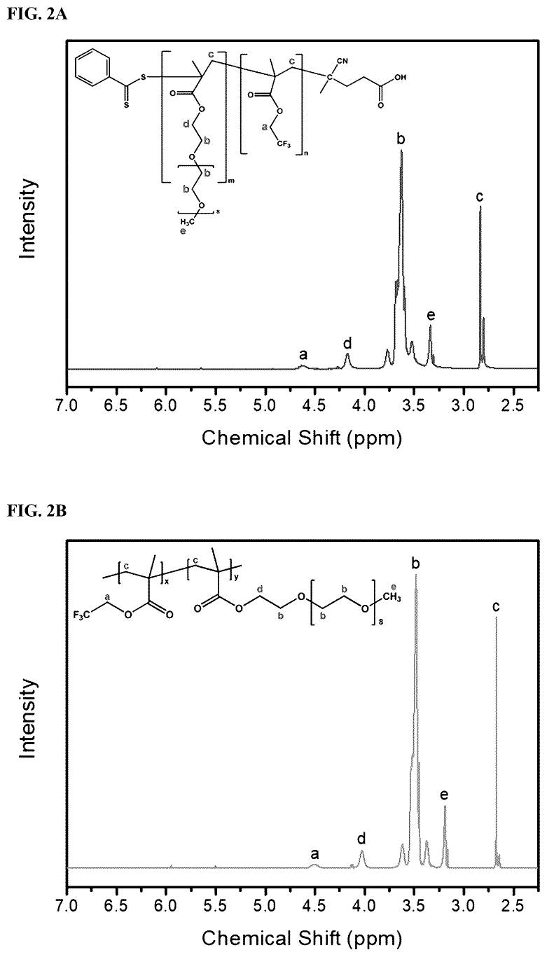

Meanwhile, the 1H NMR analysis result of the PTF block copolymer of Example 1 (FIG. 2A) and the 1H NMR result of the PTF random copolymer of Comparative Example 1 are shown in FIGS. 2A and 2B.

According to this, it was confirmed that the ratio occupied by the TFEMA part and the POEM part in the PTF block copolymer of Example 1 and the PTF random copolymer of Comparative Example 1 was 1:9.

In addition, through Gel permeation chromatography (GPC) analysis, it was confirmed that the molecular weights of the PTF block copolymer of Example 1 and the PTF random copolymer of Comparative Example 1 were 75000 g mol-1 and 73000 g mol-1, respectively, and the disparities were 1.3 and 1.5, respectively.

That is, it was confirmed that the PTF block copolymer of Example 1 and the PTF random copolymer of Comparative Example 1 were well synthesized with similar molecular weights and the same monomer synthesis ratio.

### Experimental Example 2: Observation of Copolymer Physical Properties and SAXS Analysis

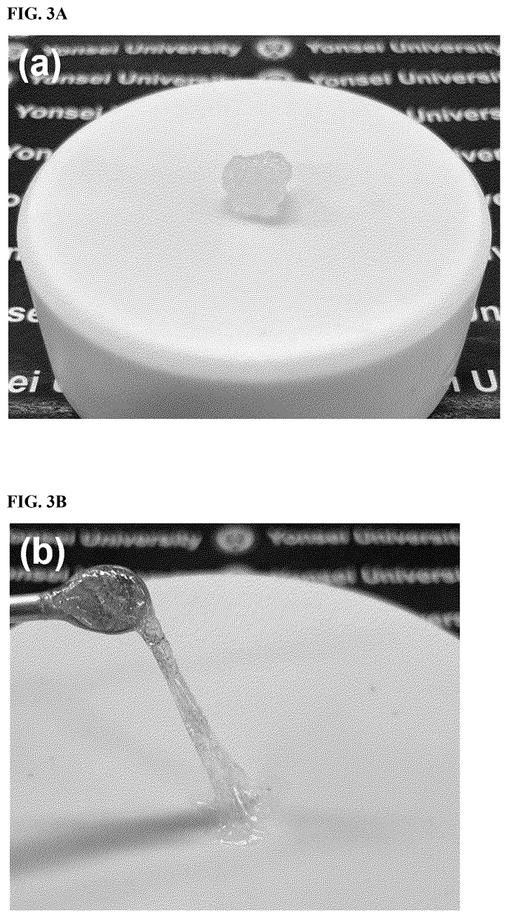

Photographs of the PTF block copolymer of Example 1 (a) and the PTF random copolymer of Comparative Example 1 (b) are shown in FIGS. 3A and 3B.

According to this, although the PTF block copolymer of Example 1 and the PTF random copolymer of Comparative Example 1 had the same molecular weight and chemical composition, it could be seen that the difference in mechanical properties was large. The PTF block copolymer of Example 1 had a regularly self-assembled structure and thus exhibited superior mechanical properties, whereas the PTF random copolymer of Comparative Example 1 was observed as a very viscous liquid state.

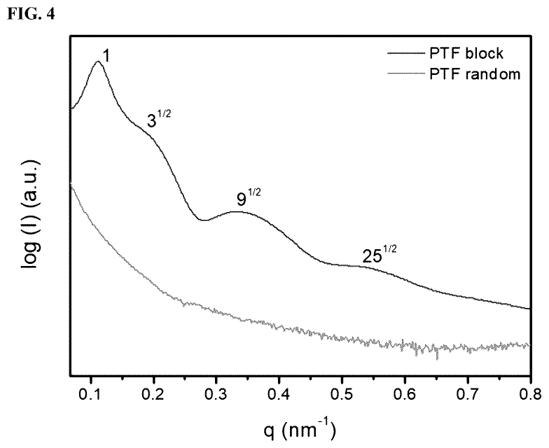

Meanwhile, the SAXS (Small-Angle X-ray Scattering) analysis results for the PTF block copolymer of Example 1 and the PTF random copolymer of Comparative Example 1 are shown in FIG. 4.

According to this, the PTF block copolymer of Example 1 showed 4 Bragg peaks, and when the positions of each peak were expressed as a ratio, they appeared as 1:3:9:25. Such results indicate that the PTF block copolymer of Example 1 formed a hexagonally packed cylinders morphology due to self-assembly. In contrast, no peaks were observed for the PTF random copolymer of Comparative Example 1 due to weak self-assembly ability.

### Experimental Example 3: TEM Image Analysis

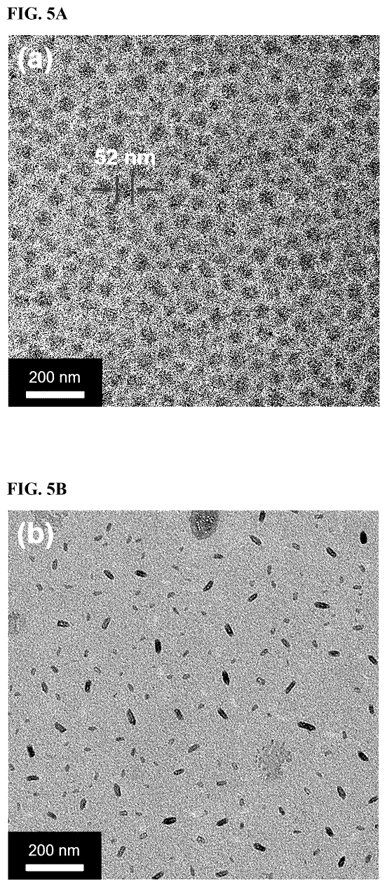

TEM images of the PTF block copolymer of Example 1 (a) and the PTF random copolymer of Comparative Example 1 (b) are shown in FIGS. 5A and 5B.

According to this, the hexagonal column structure as confirmed through the SAXS curve of the PTF block copolymer of Example 1 could also be confirmed in the TEM photograph. In the photograph, the dark part corresponds to the poly(TFEMA) region. The poly(TFEMA) region appears dark because it contains fluorine and thus has a higher electron density than the surrounding POEM region. In contrast, the PTF random copolymer of Comparative Example 1 showed an irregularly distributed structure.

### Experimental Example 4: DSC and Nano-Indenter Analysis

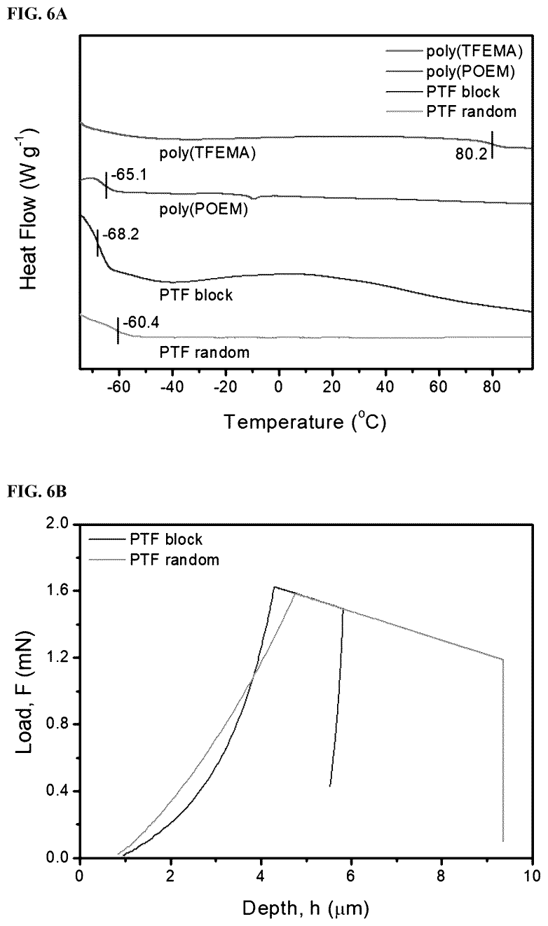

The analysis results according to Differential Scanning Calorimetry (DSC) for the PTF block copolymer of Example 1 and the PTF random copolymer of Comparative Example 1 (a) and the load-displacement curve obtained through nano-indenter analysis (b) are shown in FIGS. 6A and 6B.

According to this, the analysis according to Differential Scanning Calorimetry (DSC) of (a) is to investigate the glass transition temperature (Tg), chain movement, crystallinity, etc. of the PTF block copolymer of Example 1 and the PTF random copolymer of Comparative Example 1. The PTF block copolymer of Example 1 and the PTF random copolymer of Comparative Example 1 did not show an endothermic peak. Through this, it could be seen that both copolymers had an amorphous structure with no crystallinity. Also, the glass transition temperature (Tg) of the PTF block copolymer of Example 1 and the PTF random copolymer of Comparative Example 1 was observed around very low −60° C. Such results mean that the chain movement of the copolymer is good, making it a suitable polymer material for application to gas separation.

In addition, parameters regarding mechanical properties were obtained through the load-displacement curve obtained through the nano-indenter analysis of (b). Indentation hardness (HIT) is calculated according to Equation 1 below, and indentation creep (CIT) is calculated according to Equation 2 below. Here, Fmax is the maximum load, Ap is the contact projection area, and h1 and h2 are the indentation depths at the start and end of the creep test. hmax means the maximum indentation depth.

$${H}_{IT} = \frac{{F}_{max}}{{A}_{p}} \qquad [ Equation 1 ]$$

$${C}_{IT} = \frac{{h}_{2} - {h}_{1}}{{h}_{1}} \times 100 \qquad [ Equation 2 ]$$

The measurement results of mechanical properties according to the nano-indenter analysis are summarized in Table 1 below.

TABLE 1

| Category | H_{IT} (kPa) | C_{IT} (%) | hₘₐₓ (μm) |
|---|---|---|---|
| PTF block copolymer of Example 1 | 43 | 35.7 | 5.8 |
| PTF random copolymer of | 20 | 96.7 | 9.4 |
| Comparative Example 1 | | | |

According to this, the PTF block copolymer of Example 1 having an aligned self-assembled structure exhibited an indentation hardness (HIT) more than 2 times higher than that of the PTF random copolymer of Comparative Example 1.

### Experimental Example 5: Analysis of Carbon Dioxide Adsorption Performance and Gas Separation Performance

This shows SEM images of the thin-film composite separation membrane comprising the PTF block copolymer of Example 2 (a) and the thin-film composite separation membrane comprising the PTF random copolymer of Comparative Example 2 (b).

According to this, the thickness of the selective layer made of the PTF copolymer was about 380-390 nm. It was observed that the selective layer was in good contact with the PTMSP-coated polysulfone support.

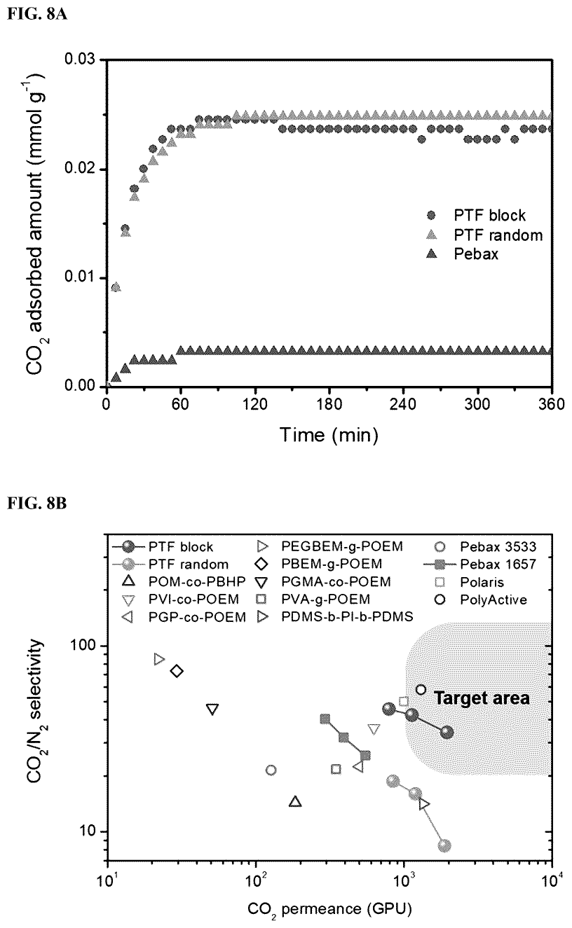

The results of measuring the carbon dioxide adsorption amount for the thin-film composite separation membrane comprising the PTF block copolymer of Example 2, the thin-film composite separation membrane comprising the PTF random copolymer of Comparative Example 2, and the commercial separation membrane Pebax (a), and the results of analyzing the gas separation performance for the thin-film composite separation membrane comprising the PTF block copolymer of Example 2, the thin-film composite separation membrane comprising the PTF random copolymer of Comparative Example 2, and various thin-film composite (TFC) separation membranes reported previously in academia are shown in FIGS. 8A and 8B.

As a result of measuring the carbon dioxide adsorption amount of (a), since the PTF copolymers of Example 2 and Comparative Example 2 of the present invention quantitatively possess the same polyethylene oxide (PEO) groups which are carbon dioxide-friendly functional groups, the carbon dioxide adsorption amount appeared to be almost the same. Also, they showed higher carbon dioxide adsorption performance than Pebax, which is a commercial block-type copolymer separation membrane. This means that the PTF copolymer is a more advantageous material for gas separation than Pebax.

In addition, according to the gas separation performance analysis results of (b), the thin-film composite separation membrane comprising the PTF block copolymer of Example 2 of the present invention showed very excellent separation performance compared to other separation membranes.

The gas separation performances of the TFC separation membrane of Example 2, the TFC separation membrane of Comparative Example 2, and Pebax are compared and summarized in Table 2 below.

TABLE 2

| Separa- | | | | | Selectivity | | |
|---|---|---|---|---|---|---|---|
| tion | Permeability (GPU) | | | | CO₂/ | CO₂/ | CO₂/ |
| membrane | CO₂ | N₂ | CH₄ | H₂ | N₂ | CH₄ | H₂ |
| Exam- | 1950 ± | 57 ± | 158 ± | 322 ± | 34.3 ± | 12.4 ± | 6.1 ± |
| ple 2 | 42 | 2 | 6 | 7 | 0.4 | 0.2 | 0.1 |
| (PTF | | | | | | | |
| block) | | | | | | | |
| Compar- | 1875 ± | 223 ± | 439 ± | 908 ± | 8.4 ± | 4.2 ± | 2.1 ± |
| ative | 58 | 8 | 10 | 15 | 0.1 | 0.1 | 0.1 |
| Exam- | | | | | | | |
| ple 2 | | | | | | | |
| (PTF | | | | | | | |
| random) | | | | | | | |
| Pebax | 341 ± | 12 ± | 28 ± | 70 ± | 28.6 ± | 12.3 ± | 4.9 ± |
| 1657 | 10 | 1 | 3 | 3 | 1.6 | 1.0 | 0.1 |

According to this, the separation membrane comprising the PTF block copolymer of Example 2 and the separation membrane comprising the PTF random copolymer of Comparative Example 2 showed similar carbon dioxide diffusivity/solubility and thus showed similar carbon dioxide permeability. However, the separation membrane comprising the PTF block copolymer of Example 2 showed a nitrogen permeability about 4 times lower than that of the separation membrane comprising the PTF random copolymer of Comparative Example 2. That is, the carbon dioxide/nitrogen selectivity appeared about 4 times higher in the separation membrane comprising the PTF block copolymer of Example 2.

Such a result is because the hexagonal column-type structure of the PTF block-type copolymer of Example 1 effectively inhibited the mass transport of nitrogen gas. Also, such a result can be supported by the difference in physical properties between the two copolymers of Example 1 and Comparative Example 1 confirmed in Experimental Example 2. This is because the stronger structure of the block-type copolymer hinders the permeation of nitrogen.

In conclusion, the separation membrane in which the present invention comprises the block copolymer of Example 1 can achieve excellent gas separation performance according to the characteristics of the structure without MOF (metal-organic framework) or COF (covalent organic framework), which are functional nanomaterial fillers added to improve gas separation performance. Conventional mixed matrix separation membranes (separation membranes introducing polymers and nanomaterial fillers) generally require efforts to improve compatibility and interfacial defects between the polymer matrix and the filler, but the PTF block copolymer prepared according to the example of the present invention can manufacture a separation membrane consisting only of polymer without adding a filler, and is very advantageous in terms of manufacturing process or manufacturing cost.

Although the embodiments of the present invention have been described above, those of ordinary skill in the art will be able to modify and change the present invention in various ways by addition, change, deletion, or addition of components within the scope not departing from the spirit of the present invention described in the claims, and this will also be said to be included within the scope of rights of the present invention.

1. An amphiphilic block copolymer for a gas separation membrane represented by the following Formula 1; 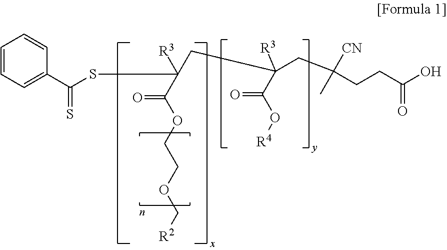
in Formula 1,
n is an integer of 5 to 30 as the number of repeating units,
x is an integer of 60 to 240 as the number of repeating units,
y is an integer of 30 to 80 as the number of repeating units,
x:y is 2:1 to 3:1, and
R¹ is a hydrogen atom, or a C₁ to C₂₀ alkyl group,
R² is a hydrogen atom, or a C₁ to C₂₀ alkyl group,
R³ is a hydrogen atom, or a C₁ to C₂₀ alkyl group,
R⁴ is 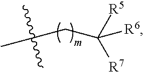
and
m is an integer of 1 to 10 as the number of repeating units, and
R⁵ to R⁷ are each independently a hydrogen atom or a fluoro group, and at least one or more are fluoro groups.

2. The amphiphilic block copolymer according to claim 1, wherein in Formula 1,
n is an integer of 7 to 15 as the number of repeating units,
x is an integer of 80 to 200 as the number of repeating units,
y is an integer of 40 to 70 as the number of repeating units,
x:y is 2:1 to 3:1, and
R¹ is a C₁ to C₁₀ alkyl group,
R² is a hydrogen atom, or a C₁ to C₁₀ alkyl group,
R³ is a C₁ to C₁₀ alkyl group,
R⁴ is R 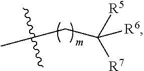
and
m is an integer of 1 to 5 as the number of repeating units, and
R⁵ to R⁷ are each independently a hydrogen atom or a fluoro group, and at least two or more are fluoro groups.

3. The amphiphilic block copolymer according to claim 2, wherein in Formula 1,
n is an integer of 8 to 12 as the number of repeating units,
x is an integer of 100 to 150 as the number of repeating units,
y is an integer of 45 to 55 as the number of repeating units,
x:y is 2:1 to 3:1, and
R¹ is a C₁ to C₄ alkyl group,
R² is a hydrogen atom, or a C₁ to C₄ alkyl group,
R³ is a C₁ to C₄ alkyl group,
R⁴ is 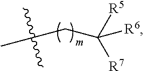
and
m is an integer of 1 to 3 as the number of repeating units, and
R⁵ to R⁷ are fluoro groups.

4. The amphiphilic block copolymer for a gas separation membrane according to claim 1, wherein the amphiphilic block copolymer is characterized in that chains are aggregated to form a hexagonal column structure.

5. A method for preparing an amphiphilic block copolymer for a gas separation membrane comprising the steps of:
(a) preparing a macro RAFT agent represented by the following Formula 3 by reacting a free radical polymerization initiator, CPAD (4-cyano-4-(phenylcarbonothioylthio)pentanoic acid), and a monomer represented by the following Formula 2 in an organic solvent; and
(b) preparing an amphiphilic block copolymer represented by the following Formula 1 by subjecting a free radical polymerization initiator, the macro RAFT agent represented by the following Formula 3, and a monomer represented by the following Formula 4 to reversible addition-fragmentation chain transfer (RAFT) polymerization in an organic solvent; 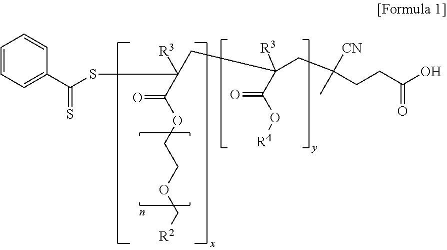
in Formula 1,
n is an integer of 5 to 30 as the number of repeating units,
x is an integer of 60 to 240 as the number of repeating units,
y is an integer of 30 to 80 as the number of repeating units,
x:y is 2:1 to 3:1, and
R¹ is a hydrogen atom, or a C₁ to C₂₀ alkyl group,
R² is a hydrogen atom, or a C₁ to C₂₀ alkyl group,
R³ is a hydrogen atom, or a C₁ to C₂₀ alkyl group,
R⁴ is 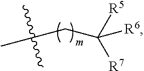
and
m is an integer of 1 to 10 as the number of repeating units, and
R⁵ to R⁷ are each independently a hydrogen atom or a fluoro group, and at least one or more are fluoro groups; 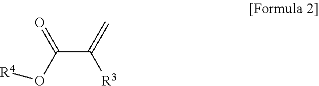
in Formula 2,
R³ is a hydrogen atom, or a C₁ to C₂₀ alkyl group,
R⁴ is 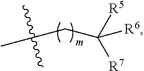
and
m is an integer of 1 to 10 as the number of repeating units, and
R⁵ to R⁷ are each independently a hydrogen atom or a fluoro group, and at least one or more are fluoro groups; 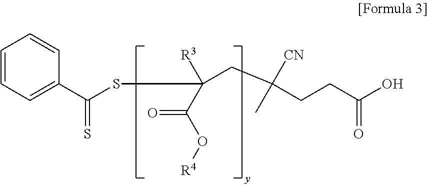
in Formula 3,
y is an integer of 30 to 150 as the number of repeating units,
R³ is a hydrogen atom, or a C₁ to C₂₀ alkyl group,
R⁴ is R 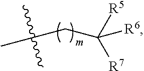
and
m is an integer of 1 to 10 as the number of repeating units, and
R⁵ to R⁷ are each independently a hydrogen atom or a fluoro group, and at least one or more are fluoro groups; and 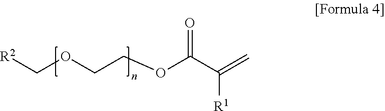
in Formula 4,
n is an integer of 5 to 30 as the number of repeating units,
R¹ is a hydrogen atom, or a C₁ to C₂₀ alkyl group, and
R² is a hydrogen atom, or a C₁ to C₂₀ alkyl group.

6. The method for preparing an amphiphilic block copolymer for a gas separation membrane according to claim 5, wherein:
in Formula 1, n is an integer of 7 to 15 as the number of repeating units,
x is an integer of 80 to 200 as the number of repeating units,
y is an integer of 40 to 70 as the number of repeating units,
x:y is 2:1 to 3:1, and
R¹ is a C₁ to C₁₀ alkyl group,
R² is a hydrogen atom, or a C₁ to C₁₀ alkyl group,
R³ is a C₁ to C₁₀ alkyl group,
R⁴ is 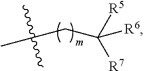
and
m is an integer of 1 to 5 as the number of repeating units, and
R⁵ to R⁷ are each independently a hydrogen atom or a fluoro group, and at least two or more are fluoro groups;
in Formula 2,
R³ is a C₁ to C₁₀ alkyl group,
R⁴ is 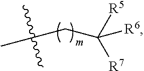
and
m is an integer of 1 to 5 as the number of repeating units, and
R⁵ to R⁷ are each independently a hydrogen atom or a fluoro group, and at least two or more are fluoro groups;
in Formula 3,
y is an integer of 20 to 100 as the number of repeating units,
R³ is a C₁ to C₁₀ alkyl group,
R⁴ is 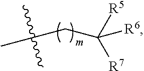
and
m is an integer of 1 to 5 as the number of repeating units, and
R⁵ to R⁷ are each independently a hydrogen atom or a fluoro group, and at least two or more are fluoro groups; and
in Formula 4,
n is an integer of 7 to 15 as the number of repeating units,
R¹ is a C₁ to C₁₀ alkyl group, and R² is a hydrogen atom, or a C₁ to C₁₀ alkyl group.

7. The method for preparing an amphiphilic block copolymer for a gas separation membrane according to claim 6, wherein:
in Formula 1,
n is an integer of 8 to 12 as the number of repeating units,
x is an integer of 100 to 150 as the number of repeating units,
y is an integer of 45 to 55 as the number of repeating units,
x:y is 2:1 to 3:1, and
R¹ is a C₁ to C₄ alkyl group,
R² is a hydrogen atom, or a C₁ to C₄ alkyl group,
R³ is a C₁ to C₄ alkyl group,
R⁴ is 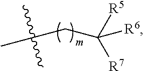
and
m is an integer of 1 to 3 as the number of repeating units, and
R⁵ to R⁷ are fluoro groups;
in Formula 2,
R¹ is a C₁ to C₄ alkyl group,
R² is a hydrogen atom, or a C₁ to C₄ alkyl group,
R³ is a C₁ to C₄ alkyl group,
R⁴ is 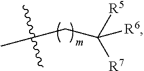
and
m is an integer of 1 to 3 as the number of repeating units, and
R⁵ to R⁷ are fluoro groups;
in Formula 3,
y is an integer of 30 to 80 as the number of repeating units,
R³ is a C₁ to C₄ alkyl group,
R⁴ is 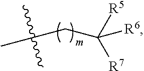
and
m is an integer of 1 to 3 as the number of repeating units, and
R⁵ to R⁷ are fluoro groups; and
in Formula 4,
n is an integer of 8 to 12 as the number of repeating units,
R¹ is a C₁ to C₄ alkyl group, and
R² is a hydrogen atom, or a C₁ to C₄ alkyl group.

8. The method for preparing an amphiphilic block copolymer for a gas separation membrane according to claim 5, wherein the free radical polymerization initiator is any one selected from azobisisobutyronitrile (AIBN), ammonium persulfate, and hydroperoxide.

9. The method for preparing an amphiphilic block copolymer for a gas separation membrane according to claim 5, wherein in step (a), the reaction is performed at 60 to 80° C.

10. The method for preparing an amphiphilic block copolymer for a gas separation membrane according to claim 5, wherein in step (a), the reaction is performed in an inert atmosphere.

11. The method for preparing an amphiphilic block copolymer for a gas separation membrane according to claim 5, wherein in step (a), the organic solvent is any one selected from n-butanol, tetrahydrofuran, chloroform, ethyl acetate, 2-butanone, 1,4-dioxane, acetone, and acetonitrile.

12. The method for preparing an amphiphilic block copolymer for a gas separation membrane according to claim 5, wherein in step (b), the macro RAFT agent represented by Formula 3 and the monomer represented by Formula 4 are polymerized in a weight ratio of 1:6 to 1:12.

13. The method for preparing an amphiphilic block copolymer for a gas separation membrane according to claim 5, wherein in step (b), the reversible addition-fragmentation chain transfer (RAFT) polymerization is performed at 60 to 70° C.

14. The method for preparing an amphiphilic block copolymer for a gas separation membrane according to claim 5, wherein in step (b), the reaction is performed in an inert atmosphere.

15. A gas separation membrane comprising the amphiphilic block copolymer for a gas separation membrane of claim 1.

16. The gas separation membrane according to claim 15, wherein the gas separation membrane further comprises a porous support, and the gas separation membrane is coated on the porous support.

17. The gas separation membrane according to claim 15, wherein the porous support comprises any one selected from polysulfone, polyethersulfone, polymethyl methacrylate, polyethylene, polypropylene, polyoxymethylene, polyetheretherketone, polyethylene terephthalate, polyacrylonitrile, cellulose acetate, polyamide, polyimide, polyamideimide, polyetherimide, polyvinylidene fluoride, polyvinyl alcohol, and polyarylate.

18. The gas separation membrane according to claim 15, wherein the gas separation membrane is coated to a thickness of 100 to 1000 nm.

19. The gas separation membrane according to claim 15, wherein the gas separation membrane is for separating one or more gases selected from carbon dioxide, nitrogen, methane, and hydrogen.

20. The gas separation membrane according to claim 15, wherein the gas separation membrane has a carbon dioxide permeability of 1900 to 2000 GPU and a CO₂/N₂ selectivity of 30 to 40.

21. A method for manufacturing a gas separation membrane comprising the steps of:
(A) preparing an amphiphilic block copolymer for a gas separation membrane according to the preparation method of claim 5;
(B) preparing an amphiphilic block copolymer solution by dissolving the amphiphilic block copolymer in an organic solvent; and
(C) coating the amphiphilic block copolymer solution on a porous support and then drying.

22. The method for manufacturing a gas separation membrane according to claim 21, wherein in step (B), the organic solvent is any one selected from water, dimethyl sulfoxide, dimethylformamide, acetic acid, acetonitrile, ethanol, methanol, and acetone.

23. The method for manufacturing a gas separation membrane according to claim 21, wherein prior to step (C), PTMSP (Poly(1-(trimethylsilyl-1-propyne))) is additionally coated on the porous support.
